(19) United States
(12) Patent Application Publication
(10) Pub. No.: US 2004/0148160 A1
(43) Pub. Date: Jul. 29, 2004

(54) Method and apparatus for noise suppression within a distributed speech recognition system

(76) Inventor: Tenkasi Ramabadran, Naperville, IL (US)

Correspondence Address: Kenneth A. Haas, Motorola, Inc., Law Department, 1303 E. Algonquin Road, Schaumburg, IL, 60196, US

(21) Appl. No.: 10/349,840

(22) Filed: Jan. 23, 2003

(51) Int. Cl. G10L 19/12

(52) U.S. Cl. 704/221

(57) ABSTRACT

A method and apparatus for noise suppression within a distributed speech recognition system is provided herein. Mel-frequency cepstral coefficients (MFCCs) values are converted to filter bank outputs (F′₀ through F′₂₂). The filter bank outputs are then used by a noise suppressor (303) for channel energy estimation, noise energy estimation, etc. Noise-suppression takes place on F′₀ through F′₂₂ and the noise-suppressed filter bank outputs F″₀ through F″₂₂ are converted back to MFCC values.

### FIELD OF THE INVENTION

The present invention relates generally to noise suppression and in particular, to a method and apparatus for noise suppression within a distributed speech recognition system.

### BACKGROUND OF THE INVENTION

Automatic speech recognition (ASR) is the method of automatically recognizing the nature of oral instructions based on the information included in speech waves. ASR has ushered in a new generation of security devices based on oral, rather than physical, keys and has made possible a whole range of “no-hands” or “hands-free” features, such as voice dialing and information retrieval by voice.

At the highest level, all ASR systems process speech for feature extraction (also known as signal-processing front end) and feature matching (also known as signal-processing back end). Feature extraction is the method by which a small amount of data is extracted from a speech input to represent the speech input. Feature matching is the method by which the nature of instructions contained in the speech input is identified by comparing the extracted data with a known data set. In a standard ASR system, a single processing unit carries out both of these functions.

The performance of an ASR system that uses speech transmitted, for example, over a mobile or wireless channel as an input, however, may be significantly degraded as compared with the performance of an ASR system that uses the original unmodified speech as the input. This degradation in system performance may be caused by distortions introduced in the transmitted speech by the coding algorithm as well as channel transmission errors.

A distributed speech recognition (DSR) system attempts to correct the system performance degradation caused by transmitted speech by separating feature extraction from feature matching and having the two methods executed by two different processing units disposed at two different locations. For example, in a DSR mobile or wireless communications system or network including a first communication device (e.g., a mobile unit) and a second communication device (e.g., a server), the mobile unit performs only feature extraction, i.e., the mobile unit extracts and encodes recognition features from the speech input. The mobile unit then transmits the encoded features over an error-protected data channel to the server. The server receives the encoded recognition features, and performs only feature matching, i.e., the server matches the encoded features to those in a known data set.

With this approach, coding distortions are minimized, and transmission channel errors have very little effect on the recognition system performance. Moreover, the mobile unit has to perform only the relatively computationally inexpensive feature extraction, leaving the more complex, expensive feature matching to the server. By reserving the more computationally complex activities to the server processor, greater design flexibility is preserved for the mobile unit processor, where processor size and speed typically are at a premium given the recent emphasis on unit miniaturization.

The European Telecommunications Standards Institute (ETSI) recently published a standard for DSR feature extraction and compression algorithms. European Telecommunications Standards Institute Standard ES 201 108, Speech Processing, Transmission and Quality aspects (STQ); Distributed speech recognition; Front-end feature extraction algorithm; Compression algorithms, Ver. 1.1.2, April 2000 (hereinafter “ETSI Front-End Standard”), hereby incorporated by reference in its entirety. While several methods, such as Linear Prediction (LP), exist for encoding data from a speech input, the ETSI Front-End Standard includes a feature extraction algorithm that extracts and encodes the speech input as a log-energy value and a series of Mel-frequency cepstral coefficients (MFCCs) for each frame. These parameters essentially capture the spectral envelope information of the speech input, and are commonly used in most large vocabulary speech recognizers. The ETSI Front-End Standard further includes algorithms for compression (by vector quantization) and error-protection (cyclic redundancy check codes). The ETSI Front-End Standard also describes suitable algorithms for bit stream decoding and channel error mitigation. At an update interval of 10 ms and with the addition of synchronization and header information, the data transmission rate works out to 4800 bits per second.

In summary, a DSR system, such as one designed in accordance with the ETSI Front-End Standard, offers many advantages for mobile communications network implementation. Such a system may provide equivalent recognition performance to an ASR system, but with a low complexity front-end that may be incorporated in a mobile unit and a low bandwidth requirement for the transmission of the coded recognition features.

The back-end of such a DSR system is continually trying to match the incoming feature vectors with reference patterns stored in its memory in order to perform recognition. This happens irrespective of whether the incoming feature vectors actually correspond to speech or to pauses between speech filled with silence or background noise. Suppressing noise has been shown to improve the recognition accuracy significantly for noisy background conditions. This is because the pattern matching part can now easily distinguish the noisy background segments by their lower energy due to noise suppression. Furthermore, in a DSR system equipped with speech reconstruction capability at the back-end, noise suppression can greatly help in reducing the fatigue of an operator listening to the synthesized speech. Therefore, a need exists for a method and apparatus for noise suppression within a distributed speech recognition system.

### BRIEF DESCRIPTION OF THE DRAWINGS

FIG. 1 is a block diagram of a distributed speech recognition system in accordance with the preferred embodiment of the present invention.

FIG. 2 is a more-detailed block diagram of the distributed speech recognition system of FIG. 1 in accordance with the preferred embodiment of the present invention.

FIG. 3 is a block diagram of the noise suppressors of FIG. 2 in accordance with the preferred embodiment of the present invention.

FIG. 4 is a flow chart showing operation of the noise suppressors of FIG. 3 in accordance with the preferred embodiment of the present invention.

### DETAILED DESCRIPTION OF THE DRAWINGS

To address the above-mentioned need, a method and apparatus for noise suppression within a distributed speech recognition system is provided herein. In accordance with the preferred embodiment of the present invention noise suppression takes place at the back end of the distributed speech recognition system, however, one of ordinary skill in the art will recognize that noise suppression may also take place at any point throughout the system. Mel-frequency cepstral coefficients (MFCCs) values are first converted to approximate filter bank outputs (F′₀ through F″₂₂). These filter bank outputs are next used by a noise suppressor for channel energy estimation, noise energy estimation, etc. and noise-suppression takes place on F′₀ through F″₂₂. The noise-suppressed filter bank outputs F″₀ through F″₂₂ are then converted back to MFCC values.

As discussed above suppressing noise has been shown to improve the recognition accuracy significantly for noisy background conditions. Additionally, in a DSR system equipped with speech reconstruction capability at the back-end, noise suppression can greatly help in reducing the fatigue of an operator listening to the synthesized speech.

The present invention encompasses a method for noise suppression within a distributed speech recognition system. The method comprises the steps of receiving a plurality of Mel-frequency cepstral coefficients (MFCCs), converting the plurality of MFCCs into a plurality of filter bank outputs, filtering the plurality of filter bank outputs to produce filtered filter bank outputs, and converting the filtered filter bank outputs to a second plurality of MFCCs.

The present invention additionally encompasses an apparatus comprising a receiver outputting a first plurality of Mel-frequency cepstral coefficients (MFCCs), a first noise suppressor having the first plurality of MFCCs as an input and outputting a first plurality of filtered MFCC values, and speech synthesis circuitry having the filtered MFCC values as an input and outputting synthesized speech based on the first plurality of filtered MFCC values.

The apparatus additionally encompasses an apparatus comprising a receiver outputting a first plurality of Mel-frequency cepstral coefficients (MFCCs), a first noise suppressor having the first plurality of MFCCs as an input and outputting a first plurality of filtered MFCC values, and speech recognition circuitry having the first plurality of filtered MFCCs as an input and utilizing the first plurality of filtered MFCCs for speech recognition.

Finally, the present invention encompasses an apparatus comprising a spectral converter having a plurality of Mel-frequency cepstral coefficients (MFCCs) as an input and outputting a plurality of filter bank outputs in the spectral domain, a noise suppressor having the filter bank outputs as an input and outputting noise-suppressed filter bank outputs, and a DSR signal generator having the noise-suppressed filter bank outputs as an input and outputting a second plurality of MFCCs based on the noise-suppressed filter bank outputs.

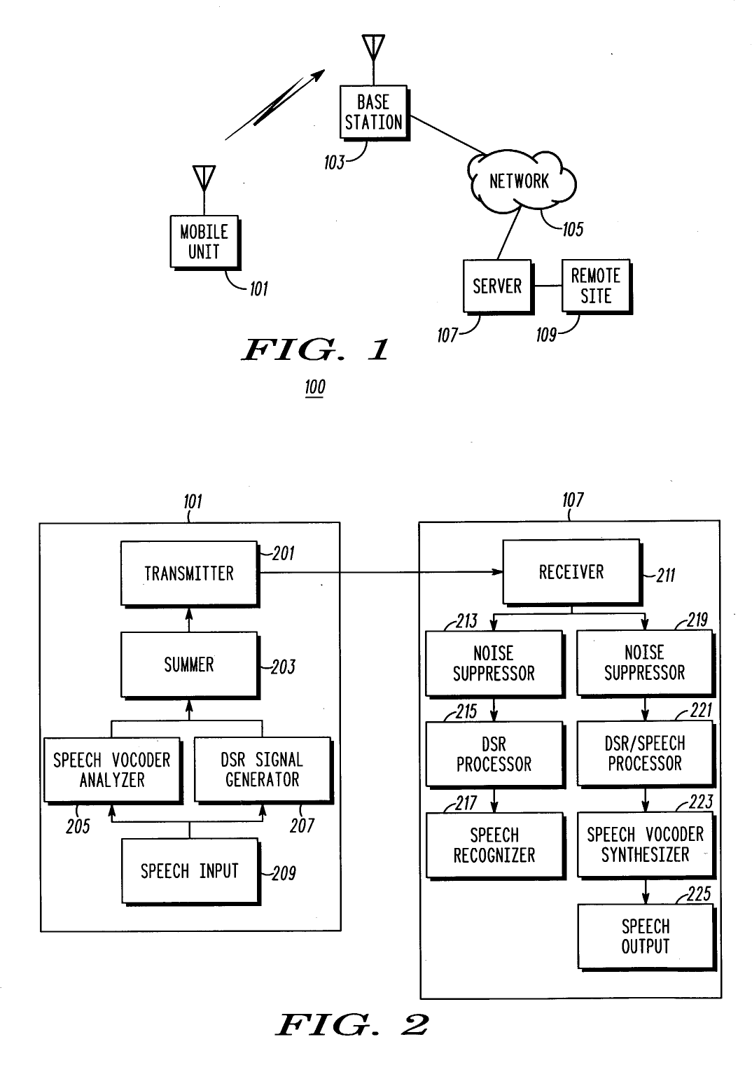

Turning now to the drawings, wherein like numerals designate like components, FIG. 1 is a block diagram of communication system 100 in accordance with the preferred embodiment of the present invention. Communication system 100 preferably comprises a standard cellular communication system such as a code-division, multiple-access (CDMA) communication system. Although the system 100 preferably is a mobile or wireless radio frequency communication system, the system 100 could be any type of communication system, for example a wired or wireless system or a system using a method of communication other than radio frequency communication.

Communication system 100 includes mobile communications device 101 (such as a mobile station) and fixed communications device 103 (such as a base station), mobile device 101 communicating with the fixed device 103 through the use of radio frequency transmissions. Base station 103, in turn, communicates with server 107 over a wired connection, as does server 107 with remote site 109. Using system 100, a user can communicate with remote site, and optionally with a user associated with remote site 109.

While only one mobile device 101, fixed device 103, server 107, and remote site 109 are shown in FIG. 1, it will be recognized that the system 100 may, and typically does, include a plurality of mobile devices 101 communicating with a plurality of fixed devices 103, fixed devices 103 in turn being in communication with a plurality of servers 107 in communication with a plurality of remote sites 109. For ease of illustration, a single mobile device 101, fixed device 103, server 107 and remote site 109 have been shown, but the invention described herein is not limited by the size of the system 100 shown.

Communication system 100 is a distributed speech recognition system as described in U.S. Pat. No. 2002/0,147,579 METHOD AND APPARATUS FOR SPEECH RECONSTRUCTION IN A DISTRIBUTED SPEECH RECOGNITION SYSTEM. As described in the '579 application mobile device 101 performs feature extraction and the server 107 performs feature matching. Communication system 100 also provides reconstructed speech at the server 107 for storage and/or verification. As discussed above, the recognition accuracy of a DSR system can be improved by means of a noise suppressor. Furthermore, the reconstruction performance (in terms of speech quality) would be better if noise suppression was performed prior to speech reconstruction. In order to address these issues, in the preferred embodiment of the present invention, noise suppression is performed at the back end to improve both speech recognition and speech output.

FIG. 2 is a more-detailed block diagram of the distributed speech recognition system of FIG. 1 in accordance with the preferred embodiment of the present invention. As is evident, the distributed speech recognition system is similar to the distributed speech recognition system of the '579 application except for the addition of noise suppressor 213 and noise suppressor 219.

As shown mobile device 10f includes speech input device 209 (such as a microphone), which is coupled to DSR signal generator 207 and speech vocoder-analyzer 205. DSR signal generator 207 extracts the spectral data about the speech input received via speech input device 209, and generates a coded signal which is representative of the spectral data (e.g., MFCC values). Vocoder-analyzer 205 extracts additional data about the speech input which may be used to reconstruct the speech at the back end (e.g., pitch period and voicing class).

Summer 203 combines the coded signal from the DSR signal generator 207 and the additional data extracted by vocoder-analyzer 205 into a unified signal, which is passed to transmitter 201 coupled to summer 203. Transmitter 201 is a radio frequency transmitter or transceiver, although as the method according to the present invention could be used with other types of communication systems, in which case the transmitter would be selected to be compatible with whatever system is selected.

DSR signal generator operates as follows in a system designed in accordance with the ETSI Front-End Standard: The speech input is converted from analog to digital, for example at a sampling frequency (Fₛ) of 8000 samples/second and 16 bits/sample. The digitized speech is passed through a DC-offset removal filter, and divided into overlapping frames. Frame size is dependant on the sampling frequency. For the ETSI Front-End Standard, which accommodates three different sampling frequencies of 8, 11, and 16 kHz, the possible frame sizes are 200, 256, and 400 samples, respectively.

The frame energy level is computed and its natural logarithm is determined. The resultant value is also referred to as the log-energy value. The framed, digitized speech signal is then passed through a pre-emphasis filter to emphasize the higher frequency components. Each speech frame is then windowed (e.g., using a Hamming window), and transformed into the frequency domain using a Fast Fourier Transform (“FFT”). Similar to the frame size, the size of the FFT used depends on the sampling frequency, for example a 256-point FFT is used for 8 and 11 kHz sampling frequencies and a 512-point FFT is used for a 16 KHz sampling frequency.

The FFT magnitudes in the frequency range between 64 Hz and Fₛ/2 (for example, 4 kHz for a sampling frequency of 8 kHz) are then transformed into the Mel-frequency domain by a process known as Mel-filtering. A transformation into the Mel-frequency domain is performed because psychophysical studies have shown that human perception of the frequency contents of sounds for speech signals does not follow a linear scale. Accordingly, for each tone with an actual frequency, ƒ, measured in Hz, a subjective pitch may be represented on a second scale, which is referred to as the Mel-frequency scale.

The Mel-filtering process is as follows. First, the frequency range (e.g., 64 Hz to 4000 Hz) is warped into a Mel-frequency scale using the expression:

$$Mel ( f ) = 2595.0 * {log}_{10} ( 1 + \frac{f}{700.0} ) .$$

Using this equation, the Mel-frequencies corresponding, for example, to frequencies of 64 Hz and 4000 Hz are 98.6 and 2146.1, respectively. This Mel-frequency range is then divided into 23 equal-sized, half-overlapping bands (also known as channels or bins), each band 170.6 wide and the center of each band 85.3 apart. The center of the first band is located at 98.6±85.3=183.9, and that of the last band is located at 2146.1−85.3=2060.8. These bands of equal size in the Mel-frequency domain correspond to bands of unequal sizes in the linear frequency domain with the size increasing along the frequency axis. The FFT magnitudes falling inside each band are then averaged (filtered) using a triangular weighting window (with the weight at the center equal to 1.0 and at either end equal to 0.0). The 23 resultant values F₀ through F₂₂ which we will refer to as filter bank outputs are then subjected to a natural logarithm operation. The 23 log-spectral values thus generated are then transformed into the cepstral domain by means of a 23-point DCT (Discrete Cosine Transform). It should be noted that only the first 13 values (C₀ through C₁₂) are calculated, with the remaining ten values (C₁₃ through C₂₂) being discarded, i.e., not computed. The frame log-energy and the 13 cepstral values (also referred to as Mel-Frequency Cepstral Coefficients, or MFCCs) are then compressed (quantized) and transmitted to fixed device 107. For communication system 100 operating according to the ETSI Front-End Standard, the MFCC and log-energy values are updated every 10 ms.

As mentioned above, vocoder-analyzer 205 also receives the speech input. In particular, vocoder-analyzer 205 analyzes the input to determine other data about the speech input which may be used by server 107 in addition to the data derivable from the DSR-coded speech to reconstruct the speech. The exact data extracted by vocoder-analyzer 205 is dependent upon the characteristics of the speech vocoder associated with server 107 which will be synthesizing the reconstructed speech. For example, Code Excited Linear Predictive (CELP) vocoders require codebook indices for each sub-frame of speech to be prepared. For parametric vocoders (e.g., sinusoidal vocoders), additional excitation data may be required, such as the voicing class (voiced, unvoiced, etc.) and the pitch period as well as higher-resolution energy data such as the sub-frame energy levels.

One will recognize that the quality of speech synthesized by CELP coders falls rapidly when the bit rate is reduced below about 4800 bps. On the other hand, parametric vocoders provide reasonable speech quality at lower bit rates. Since one of the main requirements of a DSR system is low data transmission rate, a parametric vocoder, specifically a sinusoidal vocoder, will be typically used in server 107. Consequently, according to the preferred embodiment of the invention, speech vocoder-analyzer 205 determines class, pitch period and sub-frame energy data for each speech frame, although optionally the sub-frame energy data may be omitted because the sub-frame energies may be computed by interpolation from the log-energy value.

Vocoder-analyzer 205 preferably operates on a frame size of approximately 20 ms, i.e., the parameters are transmitted once every 20 ms. In each frame, 2 bits are used for the class parameter, i.e., to indicate whether a frame is non-speech, voiced, unvoiced, or mixed-voiced. The speech/non-speech classification is preferably done using an energy-based Voice Activity Detector (VAD), while the determination of voicing level is based on a number of features including periodic correlation (normalized correlation at a lag equal to a pitch period), aperiodic energy ratio (ratio of energies of de-correlated and original frames), and high-frequency energy ratio. The pitch period parameter, which provides information about the harmonic frequencies, can typically be represented using an additional 7 bits for a typical pitch frequency range of about 55 Hz to 420 Hz. The pitch period is preferably estimated using a time-domain correlation analysis of low-pass filtered speech. If the higher-resolution energy data, e.g., sub-frame energy, parameter is to be transmitted, this may be accomplished using an additional 8 bits. The sub-frame energies are quantized in the log-domain by a 4-dimensional VQ, with the energy for non-speech and unvoiced speech frames computed over a sub-frame (4 sub-frames per frame) and the energy for voiced frames computed over a pitch period. As an alternative, the sub-frame energies may be computed from the log-energy value to reduce the bit rate.

Assuming that class, pitch period, and sub-frame energy values are transmitted every 20 ms, i.e., once for every two DSR frames if an ETSI Standard system is used, approximately 800 to 850 bps will be added to the data transmission rate. If the additional energy data is not transmitted, as little as 450 bps may be added to the data transmission rate.

The detailed structure of server 107 is now discussed with reference to the right-half of FIG. 2. Receiver 211 (which is a radio-frequency (RF) receiver) is coupled to noise suppressor 213 and noise suppressor 219. In order to perform noise suppression at the back end, where original speech is not available, the approximate filter bank outputs are reconstructed from the transmitted MFCCs, noise suppressed, and transformed back into “noise suppressed” MFCCs. In the preferred embodiment of the present invention the Mel-Frequency Cepstral Coefficients C₀ through C₁₂ are reversed by suppressors 213 and 219 to estimate the 23 filter bank outputs in the spectral domain (F′₀-F′₂₂). Noise suppressors 213 and 219 then perform standard noise suppression on the reconstructed signal (F′₀-F′₂₂) prior to converting the noise-suppressed signal back to Mel-Frequency Cepstral Coefficients C′₀ through C′₁₂. The noise suppressed MFCC values are then passed to DSR/speech processor 221 and DSR processor 215.

DSR/speech processor 221 determines and decodes the DSR-encoded spectral data, and in particular the harmonic magnitudes. First, the MFCC values corresponding to the impulse response of the pre-emphasis filter are subtracted from the received MFCC values to remove the effect of the pre-emphasis filter as well as the effect of the Mel-filter. Next, the MFCC values are inverted to compute the log-spectral value for each desired harmonic frequency. The log-spectral values are then exponentiated to get the spectral magnitude for the harmonics. Typically, these steps are performed every 20 ms, although the calculations may be made more frequently, e.g., every 10 ms.

It should be noted that in the preferred embodiment of the present invention two separate noise suppressors 213 and 219 are utilized to suppress background noise. This is done primarily because the noise suppression requirement for a speech recognizer is different from that of a speech synthesizer. For the recognizer, the recognition accuracy is of primary concern whereas for speech reconstruction, the quality and intelligibility of the output speech are of primary concern.

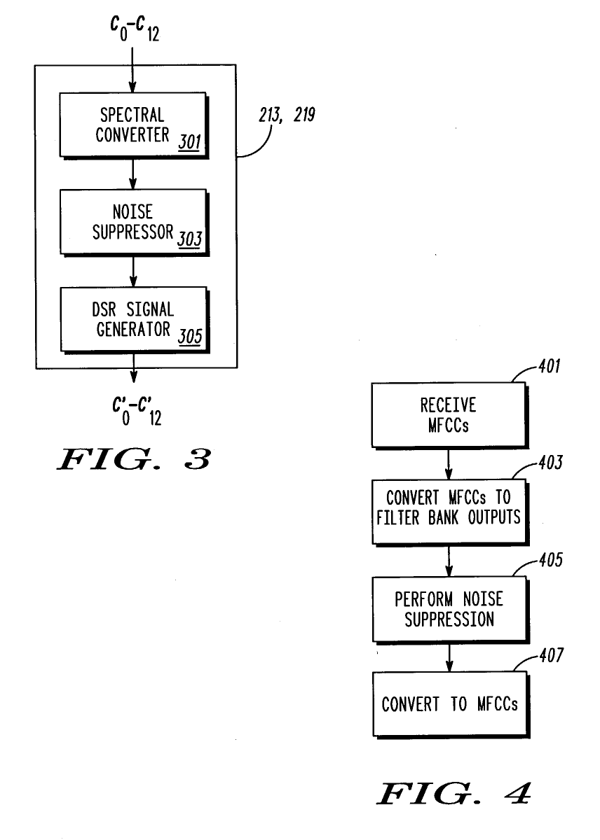

FIG. 3 is a block diagram of the noise suppressors of FIG. 2 in accordance with the preferred embodiment of the present invention. As shown, suppressors 213 and 219 comprise spectral converter 301, noise suppressor 303, and DSR signal generator 305. During operation MFCC values enter spectral converter 301 (in this case C₀ through C₁₂). As described above, in order to perform noise suppression at the back end (where original speech is not available), the received MFCC values need to be converted back into approximate filter bank outputs in the spectral domain (F′₀-F′₂₂). Spectral converter 301 performs this operation. Particularly, converter 301 performs an inverse DCT of the MFCC values followed by an exponentiation operation. The inverse DCT operation is described by the following equation:

$${D}_{i} = \frac{{C}_{0}}{23} + \frac{2}{23} {\sum }_{j = 1}^{12} {C}_{j} cos ( \frac{( 2 i + 1 ) j π}{2 * 23} ) ; i = 0 , 1 , … , 22.$$

Notice that in the above equation the unavailable Cepstral Coefficients C₁₃ through C₂₂ are assumed to be zero, however, if these values can be recovered even partially, then the (partially) recovered values of C₁₃ through C₂₂ may be used. The Dᵢ values are next exponentiated to obtain the filter bank outputs as follows:

F′ᵢ=exp(Dᵢ); i=0, 1, . . . , 22.

The filter bank outputs F′₀ through F′₂₂ obtained as above are only an approximation to the original filter bank outputs computed at the DSR front-end because of the truncation operation, i.e., the dropping of the values C₁₃ through C₂₂, (or the partial recovery of C₁₃ through C₂₂) and the quantization of the MFCC values C₀ through C₁₂. The filter bank outputs F′₀ through F′₂₂ may be regarded as average spectral magnitude estimates at the different frequency bands or channels for the current input frame. These filter bank outputs will be used by noise suppressor 303 for channel energy estimation, noise energy estimation, etc.

Noise suppressor 303 comprises standard noise suppression algorithms and utilizes the filter bank outputs for noise suppression. In the preferred embodiment of the present invention noise suppressor 303 utilizes a noise suppression algorithm as described in U.S. Pat. No. 5,687,243, NOISE SUPPRESSION APPARATUS AND METHOD and U.S. Pat. No. 4,811,404, NOISE SUPPRESSION SYSTEM. As described above, the noise suppression algorithm utilized by suppressor 303 is dependent upon whether the noise-suppressed signal is to be utilized by speech recognizer 217 or speech output 225. Thus, in the preferred embodiment of the present invention a first and a second noise suppressor both receive the MFCCs. Each suppressor outputs a plurality of noise suppressed MFCCs (C′₀ through C′₁₂) which are then output to speech recognition circuitry and speech synthesis circuitry.

Continuing, the noise suppressed filter bank outputs (that is, after they have been multiplied by the appropriate gains generated by the noise suppression algorithm) are output to DSR signal generator 305 where they are again converted to (noise-suppressed) Cepstral coefficients by taking their logarithm followed by a Discrete Cosine Transform (DCT) operation similar to those done at the DSR front-end. Since C₀ and log-E are intimately related the noise suppressed C₀ value (i.e. C′₀) is used to modify the log-E parameter appropriately. The noise-suppressed MFCCs exit generator 305 and are input to either DSR processor 215 (FIG. 2) or DSR/Speech processor 221 (FIG. 2).

FIG. 4 is a flow chart showing operation of the noise suppressors of FIG. 3 in accordance with the preferred embodiment of the present invention. The logic flow begins at step 401 where a plurality of MFCC values are received. In the preferred embodiment of the present invention step 401 comprises receiving C₀ through C₁₂. At step 403 the MFCC values are converted to filter bank outputs. As discussed above, filter bank outputs F′₀ through F′₂₂ are obtained and regarded as average spectral magnitude estimates at the different frequency bands or channels for the current input frame. These filter bank outputs are then used by noise suppressor 303 at step 405 for channel energy estimation, noise energy estimation, etc. Also at step 405 noise-suppression/filtering takes place on F′₀ through F′₂₂ to produce filtered, i.e., noise suppressed, filter bank outputs F″₀ through F″₂₂. With reference to U.S. Pat. No. 5,687,243, the values F′₀ through F′₂₂ may be regarded as input to the scalar 111 in FIG. 1 and the values F″₀ through F″₂₂ may be regarded as the output of the scalar 111 in FIG. 1. Or equivalently, with reference to U.S. Pat. No. 4,811,404, the values F′₀ through F′₂₂ may be regarded as input to the channel gain modifier 250 in FIG. 1 and the values F″₀ through F″₂₂ may be regarded as the output of the channel gain modifier 250 in FIG. 1. Finally, at step 407 the noise-suppressed filter bank outputs F″₀ through F″₂₂ are converted back to MFCC values for utilization by server 107. In particular, the noise-suppressed MFCC values are passed to speech recognition circuitry (215, 217) where speech recognition takes place or speech synthesis circuitry (221, 223, 225) where speech synthesis takes place.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for noise suppression within a distributed speech recognition system, the method comprising the steps of:
receiving a plurality of Mel-frequency cepstral coefficients (MFCCs);
converting the plurality of MFCCs into a plurality of filter bank outputs;
filtering the plurality of filter bank outputs to produce filtered filter bank outputs; and
converting the filtered filter bank outputs to a second plurality of MFCCs.

2. The method of claim 1 wherein the step of filtering the plurality of filter bank outputs comprises the step of performing noise suppression on the plurality of filter bank outputs.

3. The method of claim 1 wherein the step of receiving the plurality of MFCC components comprises the step of receiving C₀ through C₁₂.

4. The method of claim 1 further comprising the step of utilizing the second plurality of MFCCs for speech synthesis.

5. The method of claim 1 further comprising the step of utilizing the second plurality of MFCCs for speech recognition.

6. An apparatus comprising:
a receiver outputting a first plurality of Mel-frequency cepstral coefficients (MFCCs);
a first noise suppressor having the first plurality of MFCCs as an input and outputting a first plurality of filtered MFCC values; and
speech synthesis circuitry having the filtered MFCC values as an input and outputting synthesized speech based on the first plurality of filtered MFCC values.

7. The apparatus of claim 6 wherein the receiver comprises a radio frequency receiver.

8. The apparatus of claim 6 further comprising:
a second noise suppressor having the first plurality of MFCCs as an input and outputting a second plurality of filtered MFCC values; and
speech recognition circuitry having the second plurality of filtered MFCCs as an input and utilizing the second plurality of filtered MFCCs for speech recognition.

9. An apparatus comprising:
a receiver outputting a first plurality of Mel-frequency cepstral coefficients (MFCCs);
a first noise suppressor having the first plurality of MFCCs as an input and outputting a first plurality of filtered MFCC values; and
speech recognition circuitry having the first plurality of filtered MFCCs as an input and utilizing the first plurality of filtered MFCCs for speech recognition.

10. The apparatus of claim 9 wherein the receiver comprises a radio frequency receiver.

11. An apparatus comprising:
a spectral converter having a plurality of Mel-frequency cepstral coefficients (MFCCs) as an input and outputting a plurality of filter bank outputs in the spectral domain;
a noise suppressor having the filter bank outputs as an input and outputting noise-suppressed filter bank outputs; and
a DSR signal generator having the noise-suppressed filter bank outputs as an input and outputting a second plurality of MFCCs based on the noise-suppressed filter bank outputs.
